(19) United States
(12) Patent Application Publication
(10) Pub. No.: US 2020/0011698 A1
(43) Pub. Date: Jan. 9, 2020

(54) NAVIGATION SYSTEM AND NAVIGATION PROGRAM

(71) Applicant: AISIN AW CO., LTD., Anjo-shi, Aichi-ken (JP)

(72) Inventors: Hiroyoshi MASUDA, Kasugai (JP); Kazuki INOUE, Sapporo (JP); Yumi AMANO, Sapporo (JP)

(73) Assignee: AISIN AW CO., LTD., Anjo-shi, Aichi-ken (JP)

(21) Appl. No.: 16/483,335

(22) PCT Filed: Mar. 22, 2018
(86) PCT No.: PCT/JP2018/011300

§ 371 Date: Aug. 2, 2019

(30) Foreign Application Priority Data
Mar. 23, 2017 (JP) 2017-056898

(51) Int. Cl. G01C 21/36; G06F 3/0482; G06F 3/0488; G06F 3/033; G06F 3/16

(52) U.S. Cl. CPC G01C 21/3664; G06F 3/0482; G01C 21/3667; G06F 3/033; G06F 3/167; G06F 3/0488

(57) ABSTRACT

Provided is a navigation system having a first and a second input screen display unit. The first input screen displays a first input device screen for receiving input of a first option t for selection t to which any position on the display unit is input. The second input screen displays on the first input screen, a second input device screen when input to the second input device is received of a second option and the second option being arranged on the second input device screen in a direction corresponding to a specific direction, the second option being selected by the second input device and is a function different from a function selected in the first option. A button on the second input device issues a command to switch the selected second option positioned in the specific direction and a button that issues a command to determine an option.

### CROSS REFERENCE TO RELATED APPLICATIONS

This application is a National Stage of International Application No. PCT/JP2018/011300 filed Mar. 22, 2018, claiming priority based on Japanese Patent Application No. 2017-056898 filed Mar. 23, 2017.

### TECHNICAL FIELD

Aspects of the disclosure relate to a navigation system and a navigation program.

### BACKGROUND ART

An on-board device that can be operated by a remote control device and a touch panel is known. For example, Patent Document 1 describes a configuration in which a remote control selection screen or a touch panel selection screen is displayed. when an operation is selected from predetermined options such as “choose destination” and “change settings”. Here, in the remote control selection screen, an operation command is selected by a remote control device, and in the touch panel selection screen, an operation command is selected by a touch panel.

### RELATED ART DOCUMENTS

### Patent Documents

Patent Document 1: Japanese Patent Application Publication No. 2004-31741.2 (JP 2004-317412 A)

### SUMMARY OF THE DISCLOSURE

### Problem to be Solved by the Various Aspects of the Disclosure

Although options displayed on each input device screen have different icons in conventional techniques, a configuration in which options are displayed in accordance with forms of operation of a remote controller is not described. When input by a remote controller is to be enabled in a system that enables input by a touch panel, a remote controller (such as a mouse) in which a cursor is set to any position may be considered. However, when applying the configuration to a navigation system used in a vehicle, the time and effort involved in performing input is excessive. For example, when a user wishes to carry out an operation during a relatively short amount of time such as while waiting for a traffic light to change, it is difficult to carry out an operation of selecting an option by setting a cursor to any position with such a remote controller. When a user is driving a motorcycle and the user is wearing gloves, precise operations are difficult to carry out.

In order to deal with such situations, using a remote controller in which a direction is specified by a button such as a cross button that restricts a selected position in a specific direction may be considered. However, in this case, even if a screen in which an option is selected by a touch panel and a screen in which an option is selected by a remote controller are made common, it is not possible to directly select a selection item of any position with a remote controller and thus, time and effort are involved in performing input. For example, it is not until the aligned options are selected one by one and the cursor is moved to a target option, that the option can be selected. Thus, the number of times the button is operated is increased more than necessary so that it takes time to select and determine a prescribed item.

The aspects of the present disclosure were developed in view of the above problem, and it is an aspect of the disclosure to provide a technique of reducing the time and effort involved in performing input with an input device.

### Means for Solving the Problem

In order to achieve the aspects described above, the navigation system includes: a first input receiving unit that receives selection of a first option through input to a first input device to which any position on a display unit is input; a second input receiving unit that receives input to a second input device that includes a button that issues a command to switch a second option that is selected to the second option that is positioned in a specific direction and a button that issues a command to determine an option; a first input screen display unit that displays on a display screen, a first input device screen for receiving input of the first option that is configured to be selected by the first input device; and a second input screen display unit that displays on the first input device screen, a second input device screen when input to the second input device is received, the second input device screen being for receiving input of the second option and the second option being arranged on the second input device screen in a direction corresponding to the specific direction, the second option being configured to be selected by the second input device and in which a function that is different from a function selected in the first option is selected.

In order to achieve the aspects described above, a navigation program causes a computer to function as: a first input receiving unit that receives selection of a first option through input to a first input device to which any position on a display unit is input; a second input receiving unit that receives input to a second input device that includes a button that issues a command to switch a second option that is selected to the second option that is positioned in a specific direction and a button that issues a command to determine an option; a first input screen display unit that displays on a display screen, a first input device screen for receiving input of the first option that is configured to be selected by the first input device; and a second input screen display unit that displays on the first input device screen, a second input device screen when input to the second input device is received, the second input device screen being for receiving input of the second option and the second option being arranged on the second input device screen in the specific direction, the second option being configured to be selected by the second input device and in which a function that is different from a function selected in the first option is selected.

That is, in the navigation system and the program, an input by the first input device is received when the first input device screen is displayed and an input by the second input device is received when the second input device screen is displayed. In the first input device screen and the second input device screen, the options for receiving input are different from each other. Thus, it is possible to prepare an option that is suitable for each input device and reduce the time and effort involved in performing input with the input device. In the second input device screen, the second options are arranged in a direction corresponding to a specific direction. In the second input device, the second option that is selected can be switched to another second option that is at a position in the specific direction with the button. Thus, the second options are displayed on the second input device screen in accordance with the direction that can be selected by the button of the second input device, and the second option can be easily selected with the second input device.

In order to achieve the aspects described above, a navigation system may include: a first input receiving unit that receives selection of a first option through input to a first input device to which any position on a display unit is input; a second input receiving unit that receives input to a second input device that includes a button that issues a command to switch a second option that is selected to another second option and a button that issues a command to determine an option; a first input screen display unit that displays on a display screen, a first input device screen for receiving input of the first option that is configured to be selected by the first input device; and a guiding unit that performs guidance by sound for receiving input of the second option that is configured to be selected by the second input device and in which a function that is different from a function selected in the first option is selected. That is, it is possible to reduce the time and effort involved in performing input with an input device if a different option can be prepared for the first input device and the second input device, even if input by the second input device is received by guidance by sound.

### BRIEF DESCRIPTION OF THE DRAWINGS

FIG. 1 is a block diagram illustrating a navigation system.

FIG. 2A is an example of a first input device screen, and FIG. 2B is an example of a second input device screen.

FIGS. 3A and 3B are examples of the first input device screen.

FIGS. 4A and 4B are examples of the first input device screen.

FIGS. 5A and 5B are examples of the second input device screen.

### DETAILED DESCRIPTION

Hereinafter, various embodiments will be described in the following order:

(1) Configuration of Navigation System:

(2) Example of Operation:

(3) Other Embodiments:

### (1) CONFIGURATION OF NAVIGATION SYSTEM

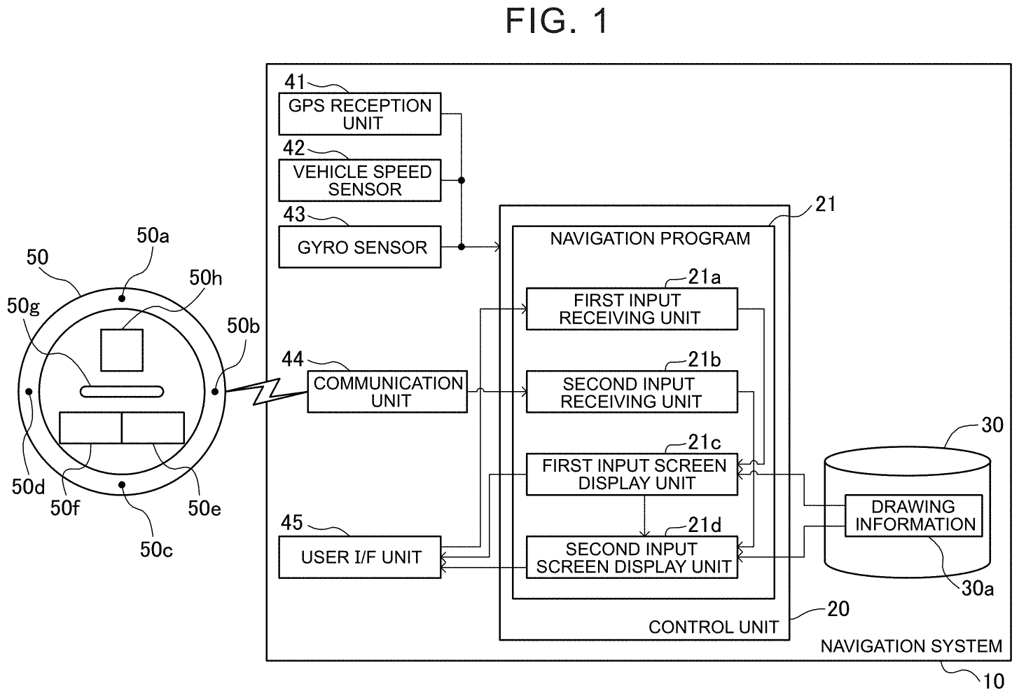

FIG. 1 is a block diagram illustrating a configuration of a navigation system 10 that is a first embodiment of the disclosure. The navigation system 10 has a control unit 20 that includes a CPU, a RAM, a ROM, and so forth. The control unit 20 can execute a desired program recorded in the ROM or a recording medium 30. In the embodiment, the control unit 20 can execute a navigation program 21 as one of the programs. The navigation program 21 can cause the control unit 20 to implement a function of displaying a map on a display and a function of searching and providing guidance for a route to a destination.

Map information, not shown, and drawing information 30a for drawing an image is recorded in the recording medium 30. The map information is information used for searching for a route and identifying a present location of a vehicle. The map information includes node data that indicate positions of nodes set on a road that a vehicle travels along, shape interpolation point data that indicate positions of shape interpolation points for specifying the shape of roads between nodes, link data that indicate connections between nodes, and data that indicate positions of features that are on or around roads etc. The link data are correlated with a link cost of a road section indicated by each link, and route search is implemented by a method in which the link cost of a route is minimized.

The navigation system 10 includes a GPS reception unit 41, a vehicle speed sensor 42, a gyro sensor 43, a communication unit 44, and a user I/F unit 45. The UPS reception unit 41 receives radio waves from a UPS satellite and outputs a signal for computing the present location of the vehicle via an interface not shown. The vehicle speed sensor 42 outputs a signal corresponding to a rotational speed of wheels of the vehicle. The control unit 20 acquires the signal via an interface not shown and acquires the vehicle speed. The gyro sensor 43 detects an angular acceleration when the vehicle turns on a horizontal plane and outputs a signal corresponding to a direction in which the vehicle is headed.

The control unit 20 acquires the signal to acquire the traveling direction of the vehicle. The control unit 20 acquires the present location of the vehicle by identifying a traveling path of the vehicle based on the signals output from the vehicle speed sensor 42 and the gyro sensor 43 etc. The signal output from the UPS reception unit 41 are used for correcting the present location of the vehicle identified based on the vehicle speed sensor 42 and the gyro sensor 43 etc.

The user I/F unit 45 is an interface unit for providing a user with various information and for receiving various inputs from the user. The user I/F unit 45 includes a display, an operation input unit, a speaker, a microphone etc. that are not shown. Through the function of the navigation program 21, the control unit 20 can refer to the drawing information 30a, draw an image that indicates a map of a periphery of the present location of the vehicle and search results of routes and facilities etc., and display the drawn image on the display.

In the embodiment, the display of the user I/F unit 45 is a touch panel display. The control unit 20 can thus detect a touch operation to the touch panel by the user, based on signals output from the display of the user I/F unit 45. In the embodiment, the touch panel is a first input device and the user can input any position on the display of the user I/F unit 45 by touching the touch panel. The user can thus directly select (with one action) an option displayed on any position on the display.

The communication unit 44 includes a circuit for performing wireless communication with a remote controller 50. The control unit 20 can acquire signals output from the remote controller 50 in a wireless manner. In the embodiment, the remote controller 50 performs wireless communication using short-range radio communication standards (for example, Bluetooth (registered trademark)) that are determined beforehand. However, the form of connecting the remote controller 50 and the navigation system 10 is not limited to the above. For example, the remote controller 50 and the navigation system 10 may be connected using other standards or by wired communication.

The remote controller 50 of the embodiment includes buttons 50a to 50g and a rotation input unit 50h. When the buttons 50a to 50g are pushed, the remote controller 50 outputs information that indicate that the buttons are turned on. The rotation input unit 50h is an input unit that is rotatable around a rotational axis. When the user moves his/her finger in an upward direction or a downward direction in FIG. 1 while touching the rotation input unit 50h, the rotation input unit 50h rotates and outputs information indicating a rotational direction at frequency based on a rotational speed. The control unit 20 can identify the content input to the remote controller 50 based on the outputs. In the embodiment, the remote controller 50 is a second input device.

The control unit 20 can select various functions through processing performed by the navigation program. For example, the control unit 20 can execute a function of inputting a destination, searching for a route to the destination, performing guidance of a searched route, displaying facilities on a map etc. in the embodiment, options based on various processing that can be executed by the control unit 20 are provided, and the user selects an option and thereby can select a function corresponding to the option. In the embodiment, the control unit 20 can execute the various functions through receiving a selection of the option through a plurality of input devices. That is, in the embodiment, the control unit 20 can receive input to the touch panel of the user I/F unit 45 from the user and input to the remote controller 50 from the user.

The navigation program 21 includes a first input receiving unit 21a, a second input receiving unit 21b, a first input screen display unit 21c, and a second input screen display unit 21d. The first input receiving unit 21a is a program module that causes the control unit 20 to implement a function of receiving a selection of a first option through input to the first input device to which any position on the display unit is input. That is, when the user touches the touch panel, the control unit 20 acquires information output from the user I/F unit 45 and identifies a touch position varying over time.

The control unit 20 identifies the touch position on the touch panel based on the touch position varying in time and identifies the touch position varying in time. For example, suppose the information output from the user I/F unit 45 indicates that touch operation is completed after touch operation is performed to a specific position for an amount of time equal to or less than a predetermined amount of time. In this case, the control unit 20 confirms that the user has performed touch operation to the specific position.

The second input screen display unit 21c is a program module that causes the control unit 20 to implement a function of displaying, on the display unit, the first input device screen for receiving input of the first option that can be selected through the first input device. That is, image information that indicates the first input device screen including the first options is recorded beforehand in the recording medium 30 as the drawing information 30a, and the control unit 20 causes the touch panel display of the user I/F unit 45 to display the first input device screen by referring to the drawing information 30a.

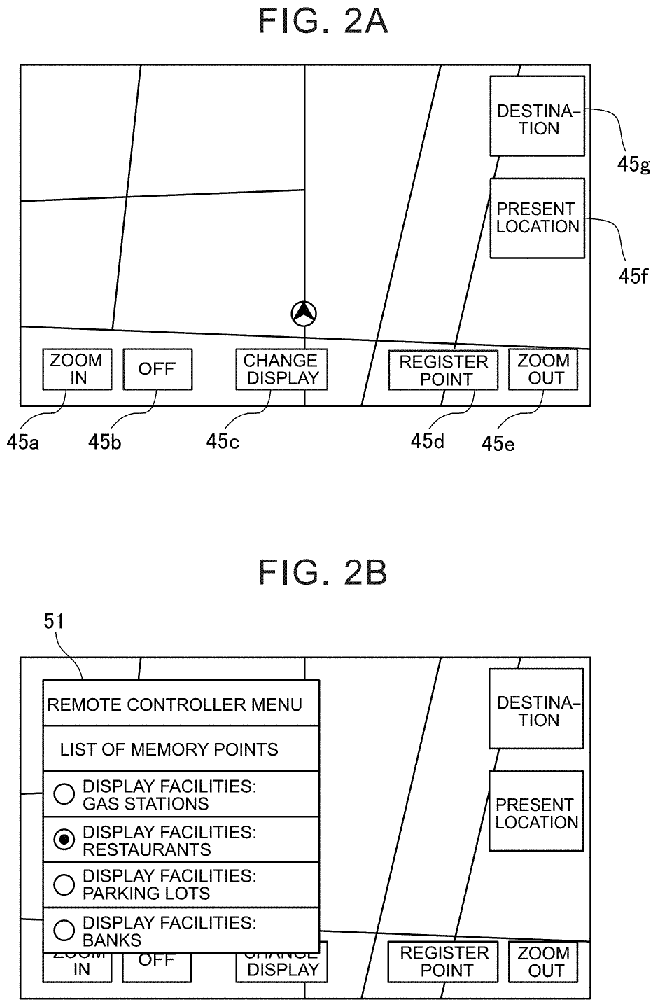

FIG. 2A illustrates an example of an image displayed on the touch panel display of the user I/F unit 45. In the example, the first input device screen is displayed as a drawing layer that is displayed on the map through processing performed by the navigation program 21. That is, the buttons 45a to 45g are displayed as the first options by overlapping with the map. Various functions are assigned to the buttons 45a to 45g. In the example illustrated in FIG. 2A, a function of changing a scale of the map so that a narrow area is displayed is assigned to the button 45a, a function of switching the buttons 45a to 45f to a simplified display is assigned to the button 45b, and a function of starting input for changing how the map is displayed is assigned to the button 45c. In the same example, a function of starting a processing of registering a desired point as a memory point is assigned to the button 45d, a function of changing the scale of the map so that a wide area is displayed is assigned to the button 45e, a function of starting to input a destination is assigned to the button 45g, and a function of displaying the map of the present location is assigned to the button 45f.

In this way, when the first input device screen is displayed, the control unit 20 identifies the input content based on the position of the first options displayed on the touch panel display of the user I/F unit 45 through processing performed by the first input receiving unit 21a. That is, when touch operation is performed to the first option while the first input device screen is displayed on the touch panel display of the user I/F unit 45, the control unit 20 assumes that the first option of the touched position is selected, and starts processing corresponding to the selected first option. For example, in the example illustrated in FIG. 2A, when touch operation is performed to a position within the button 45c, the control unit 20 starts processing of changing how the map is displayed. When touch operation is performed to a position within the button 45g, the control unit 20 starts inputting the destination.

The second input receiving unit 21b is a program module that causes the control unit 20 to implement a function of receiving input to the second input receiving unit. Here, the second input receiving unit includes a button that issues a command to switch a second option that is selected to the second option that is positioned in a specific direction, and a button that issues a command to determine the option. That is, the control unit 20 acquires information output from the remote controller 50 when the user operates the remote controller 50, and identifies the operated button (hereinafter, if there is no need to specifically make a distinction, an operation will be referred to as an operation of the button, even when the rotation input unit 50h is operated).

The second input screen display unit 21d is a program module that causes the control unit 20 to implement a function of displaying the second input device screen on the first input device screen. The second input device screen is the screen for receiving input of the second option in which a function that can be selected through the second input device and that is different from the function selected in the first option is selected, when input to the second input device is received. The second options are arranged on the second input device screen in a direction corresponding to the specific direction. Image information indicating the second input device screen including the second options are also recorded beforehand in the recording medium 30 as the drawing information 30a. When any button of the remote controller 50 is operated, the control unit 20 refers to the drawing information 30a and causes the touch panel display of the user I/F unit 45 to display the second input device screen.

FIG. 2B illustrates an example of an image displayed on the touch panel display of the user I/F unit 45. In the example, the second input device screen is displayed as a drawing layer that is displayed on the map through processing performed by the navigation program 21. That is, a remote controller menu 51 serving as the second input device screen is displayed while overlapping with the map. In the remote controller menu 51, the second options that are the options that can be selected are displayed so as to be arranged in an up-down direction.

In an example illustrated in FIG. 2B, the second options are options for selecting the destination. That is, the option “list of memory points” is an option for displaying a list of points that are registered beforehand by the user as memory points and then selecting a function that starts a processing of selecting a memory point from the list and setting the selected memory point as the destination. The options marked “display facilities:” are options for selecting a function of displaying facilities of an attribute marked after the colon (in this case, the user sets a facility on the map as the destination by himself/herself).

In this way, when the second input device screen is displayed, the control unit 20 identifies the content of the command issued from the button operated by the remote controller 50 based on the position of the second option displayed on the touch panel display of the user I/F unit 45 through processing performed by the second input receiving unit 21b. That is, the content of the command issued from each of the buttons are identified beforehand. For example, commands of moving upward and downward are assigned to the buttons 50a, 50c, respectively, and a determining command is assigned to the button 50g.

When the remote controller 50 is operated while the second input device screen is displayed on the touch panel display of the user I/F unit 45, the control unit 20 identifies the content of the command assigned to the button in accordance with the operated button and starts a processing in accordance with the content of command. For example, in the example of the second input device screen illustrated in FIG. 2B, a form in which the selected second option is indicated by a radio button or a color is adopted. In FIG. 2B, the second option that issues a command to start the function of displaying facilities of a restaurant attribute on the map is selected. In this case, when the button 50a is operated, the control unit 20 switches the second option that is selected to the second option just above the second option that is selected (the second option that issues a command to start a function of displaying facilities of a gas station attribute on the map).

When the button 50c is operated, the control unit 20 switches the second option that is selected to the second option just below the second option that is selected (the second option that issues a command to start a function of displaying facilities of a parking lot attribute on the map). When the button 50g is operated, the control unit 20 starts the function of displaying facilities of the restaurant attribute. In the embodiment, the directions of the buttons 50a, 50c on the remote controller 50 are specific directions, and the specific directions are the up-down direction of the remote controller menu 51. The second options are arranged linearly in the up-down direction of the remote controller menu 51. In the embodiment, it is thus possible to select the second option with one of the buttons 50a, 50c provided by the remote controller 50 and determine the selection of the second option with the button 50g.

As described above, in the embodiment, the user can use the touch panel and the remote controller 50 to select an option and cause the control unit 20 to execute the various functions. In the embodiment, the first options in the first input device screen and the second options in the second input device screen are selected so that the screens correspond to the characteristics of the input devices.

That is, in the embodiment, the remote controller 50 has less flexibility of input information compared to the touch panel. Specifically, in the touch panel, information indicating coordinates of a plurality of touch points varying over time is output so that it is possible to distinguish touch operation to any position on the panel and combinations of touch operations (swiping and pinch-in operation etc.). The coordinates are values within a range corresponding to the size of the touch panel, and may take at least several tens or hundreds of coordinates for the x coordinate and the v coordinate. In contrast, the remote controller 50 outputs information indicating that the buttons 50a to 50g are turned on and information indicating the rotational direction of the rotation input unit 50h. The output of the remote controller 50 just indicates whether the buttons are turned on or off and indicates the rotational direction of the buttons, in which the buttons are equal to or less than ten in amount. The remote controller 50 has less flexibility of input information compared to the touch panel.

In the embodiment, the remote controller 50 thus has more restriction as an input device compared to the touch panel. In the embodiment, the second options that are the options for the remote controller 50 are more limited than the first options, and the number of times a menu layer needs to be switched in order to achieve the target is reduced. That is, only the options for selecting the destination are included in the second input device screen (remote controller menu 51) illustrated in FIG. 2B. The buttons 45a, 45e etc. for changing the scale of the map are included in the first input device screen illustrated in FIG. 2A in addition to the buttons 45g, 45c for selecting the functions related to the destination. The options for the remote controller 50 are thus more limited.

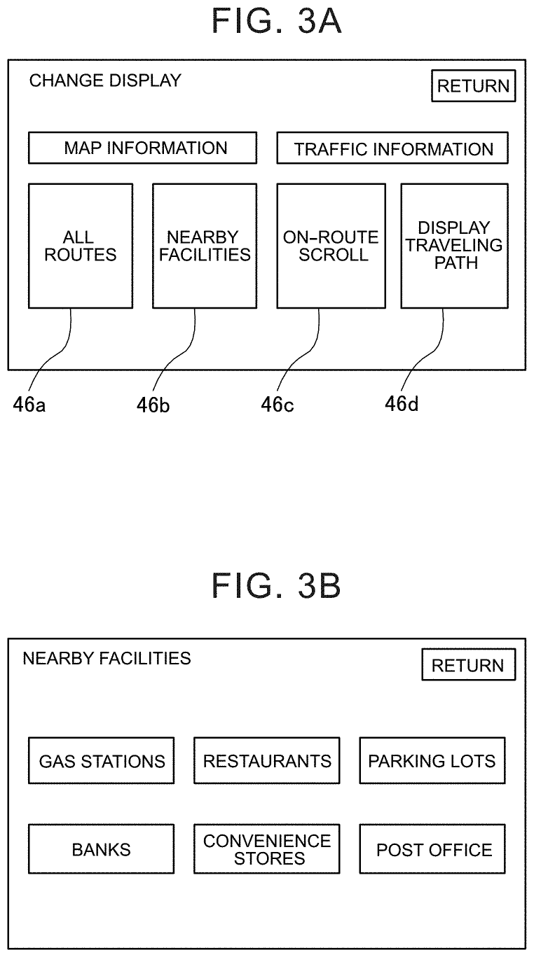

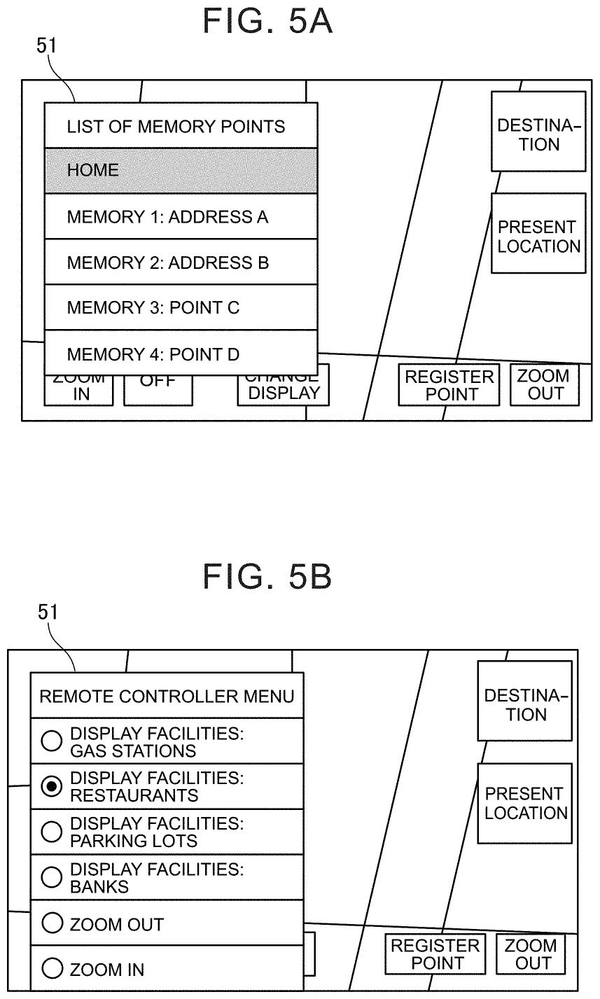

The number of times the menu layer needs to be switched in the second input device screen in order to start inputting and displaying the destination is less than the number of times the menu layer needs to be switched in the first input device screen. That is, in the embodiment, the first input device screen and the second input device screen have configurations in which the details of the option selected on the upper menu layer are selected by the options on a lower menu layer. For example, when the button 45c on the first input device screen illustrated in FIG. 2A is touched, the screen is switched to the first input device screen illustrated in FIG. 3A and the details are selected. When the list of memory points is selected in the second input device screen (remote controller menu 51) illustrated in FIG. 2B, the screen is switched to the second input device screen illustrated in FIG. 5A and the details are selected.

In such a configuration, suppose the button 50g is operated while a second option for displaying facilities on the second input device screen illustrated in FIG. 2B is selected. In such a case, the attribute of the facilities that are to be displayed is set at this stage and the control unit 20 extracts the facilities of the attribute from the map information and causes the facilities to be displayed on the map. In contrast, when the button 45c is touched on the first input device screen illustrated in FIG. 2A, the control unit 20 starts a processing for changing the display, and in the embodiment, the user sets the attribute of the facilities to be displayed through options on a deeper menu layer (as discussed in detail later). In the embodiment, the second input device screen is structured such that the number of times the menu layer needs to be switched in order to achieve the target is less than that in the first input device screen.

In the embodiment described above, the options for receiving input are different in the first input device screen and the second input device screen. Although the functions that can be selected are limited in the second input device screen, which is more restricted, it is possible to achieve the target by selecting the function in fewer menu layers than in the first input device screen. Thus, it is possible to reduce the time and effort involved in performing input with the second input device. In the second input device screen, the second options are arranged in a direction corresponding to a specific direction. In the second input device, the second option that is selected can be switched to another second option that is at a position in the specific direction with the button. Thus, the second options are displayed on the second input device screen in accordance with the direction that can be selected by the button of the second input device, and the second option can be easily selected with the second input device.

(2) Example of Operation:

An example of operation of the embodiment will be described. A default screen displayed on the touch panel display of the user I/F unit 45 by the control unit 20 in the embodiment is a screen such as the screen in FIG. 2A. That is, the map of the periphery of the present location of the vehicle and the first input device screen that receives input through the touch panel are displayed on the screen. When the user touches the button 45c in this state, the control unit 20 determines that the button 45c has been touched and starts a processing of receiving input for changing the display of the map, through processing performed by the first input receiving unit 21a.

In this case, the control unit 20 outputs control signals to the touch panel display of the user I/F unit 45 and causes the first input device screen for performing input to change the display of the map to be displayed, through processing performed by the first input screen display unit 21c. FIG. 3A is a screen for performing input to change the display of the map. On the screen, buttons 46a, 46b for changing the display of the map information and buttons 46c, 46d for changing the display of traffic information are displayed as the first options.

To display facilities that may be the destination near the present location on the map, the user touches the button 46b. When the user touches the button 46b, the control unit 20 determines that the command to change the display of the nearby facilities is issued and switches the screens, through processing performed by the first input receiving unit 21a. That is, the control unit 20 causes the first input device screen to be displayed through processing performed by the first input screen display unit 21c. Here, in the first input device screen, the attributes of the nearby facilities to be displayed are listed as the first options.

FIG. 3B is an example of the first input device screen indicating a list of the attributes of the facilities that can be selected to be displayed. When the user selects one of the nearby facilities while the first input device screen is displayed, the attribute of the nearby facilities to be displayed is set and the control unit 20 refers to the map information to extract the facilities of the selected attribute and causes icons of the facilities to be displayed on the map.

In contrast, when the user operates any button of the remote controller 50 while the first input device screen illustrated in FIG. 2A is displayed, the control unit 20 outputs control signals to the touch panel display of the user IF unit 45 to display the remote controller menu 51 through processing performed by the second input screen display unit 21.d. As a result, transition is performed to a screen such as the screen illustrated in FIG. 2B.

When the user operates the remote controller 50 in this state, the control unit 20 identifies the command of the user based on the output of the remote controller 50, through processing performed by the second input receiving unit 21b. In the remote controller menu 51, there are options for displaying on the map, facilities of the following attributes: gas stations; restaurants; parking lots; and banks. When the user selects one of these options with the remote controller 50, the attribute of the nearby facilities to be displayed is set, and the control unit 20 refers to the map information to extract the facilities of the selected attribute and causes the icons of the facilities to be displayed on the map.

In the embodiment, when the remote controller 50 is used, it is possible to set the facilities to be displayed by selecting the second option on the top layer in the remote controller menu 51 displayed first. In contrast, when the touch panel is used, the button 45c is selected as the first option on the first input device screen (FIG. 2A) displayed first, the button 46b is selected as the first option on the menu layer (FIG. 3A) immediately after, and the facility attribute is selected as the first option on the menu layer (FIG. 3B) immediately after the menu layer (FIG. 3A) so that the facility to be selected can be set. Thus, the number of times the menu layer needs to be switched in the second input device screen to display the facilities of the periphery of the present location is less than the number of times the menu layer needs to be switched in the first input device screen to display the map of the periphery of the present location.

In the default state illustrated in FIG. 2A, when the user touches the button 45g, the control unit 20 determines that the button 45g has been touched and starts the processing of receiving input of the destination, through processing performed by the first input receiving unit 21.a.

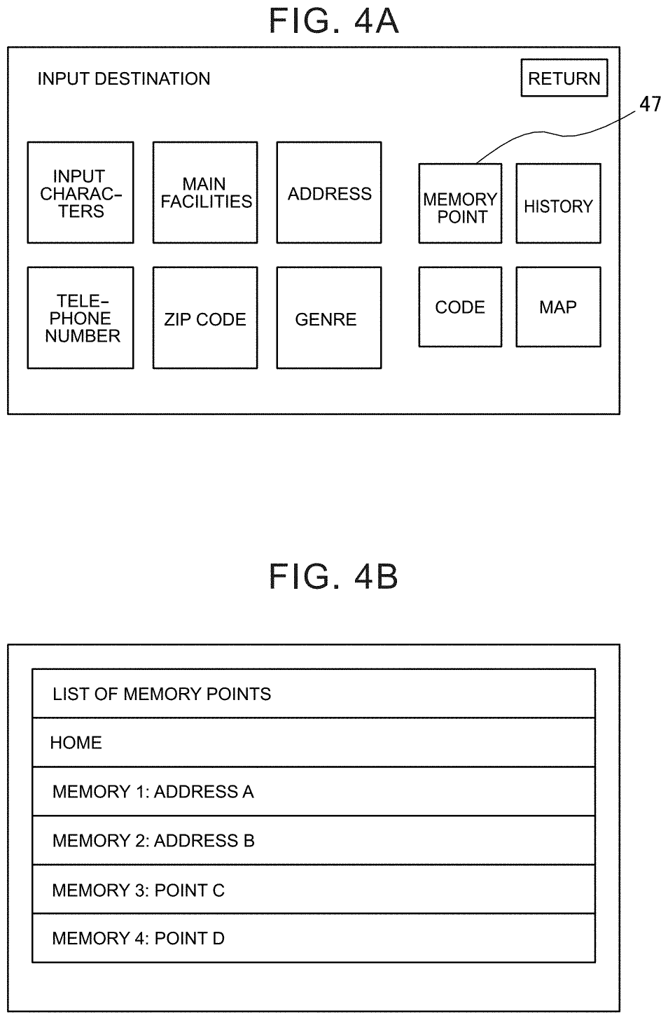

In this case, the control unit 20 outputs control signals to the touch panel display of the user I/F unit 45 and causes the first input device screen for performing input of die destination to be displayed, through processing performed by the first input screen display unit 21c. FIG. 4A is a screen for inputting the destination. In the screen, it is possible to input the destination in a plurality of input modes, and buttons in accordance with the input modes are displayed as the first options.

To input the destination by selecting the memory point that was stored beforehand by the user, the user touches a button 47. When the user touches the button 47, the control unit 20 determines that a command to select the memory point has been issued and switches the screens, through processing performed by the first input receiving unit 21a. That is, the control unit 20 refers to information, not shown, recorded in the recording medium 30 to extract the memory points and causes the first input device screen in which the memory points are listed as the first options to be displayed, through processing performed by the first input screen display unit 21c.

FIG. 4B is an example of the first input device screen in which the memory points are listed. When the user touches a memory point while the first input device screen is displayed, the destination is set. The control unit 20 searches for a route from the present location to the destination and starts route guidance.

In contrast, when the user operates the remote controller 50 while the second input device screen such as the screen illustrated in FIG. 2B is displayed, the control unit 20 identifies the command of the user based on the output of the remote controller 50, through processing performed by the second input receiving unit 21b. In the remote controller menu 51, there is the option to issue a command to display the list of memory points, as the second option. When the user selects the option with the remote controller 50, the control unit 20 switches the displayed contents of the remote controller menu 51 to those as illustrated in FIG. 5A, through processing performed by the second input screen display unit 21d. That is, the control unit 20 refers to information, not shown, recorded in the recording medium 30 to extract the memory points and causes the second input device screen in which the memory points are listed as the second options to be displayed.

When the user operates the remote controller 50, moves the selected option (shown in gray in FIG. 5A) with the buttons 50a, 50c, and issues a command to set the selected option with the button 50g, the control unit 20 sets the selected memory point as the destination, through processing performed by the second input receiving unit 21b. The control unit 20 then searches for the route from the present location to the destination and starts route guidance.

As described above, in the embodiment, it is possible to set the destination by selecting the second option on the menu layer (FIG. 5A) immediately after the remote controller menu 51 that is displayed first, when the remote controller 50 is used. In contrast, when the touch panel is used, the destination can be set after selecting the button 45g as the first option on the first input device screen (FIG. 2A) that is displayed first, selecting the button 47 as the first option on the menu layer (FIG. 4A) immediately after, and selecting the destination as the first option on the menu layer (FIG. 4B) immediately after the menu layer (FIG. 4A). Thus, the number of times the menu layer needs to be switched in the second input device screen for inputting the destination is less than the number of times the menu layer needs to be switched in the first input device screen.

### (3) OTHER EMBODIMENTS

The embodiment described above is an example for carrying out the invention, and a variety of other embodiments can be adopted as long as the options that differ depending on the input device are displayed on the screen for each input device. For example, a mobile body that moves with the navigation system 10 is optional, and may be a vehicle or a pedestrian, and various examples can be assumed. The navigation system may be a device mounted on a vehicle etc., a device that is implemented by a portable terminal, or a system that is implemented by a plurality of devices (such as a client and a server).

At least a part of the first input receiving unit 21a, the second input receiving unit 21b, the first input screen display unit 21c, and the second input screen display unit 21d may be provided separately in a plurality of devices. A part of the configuration of the embodiment described above may be omitted, the order of the processing may be changed, or some of the processing may be omitted.

The first input receiving unit should be capable of receiving input to the first input device and the second input receiving unit should be capable of receiving input to the second input device. That is, the navigation system should be capable of receiving input from at least two different input devices. Various forms can be assumed as a form of the input device, and the form is not limited to the combination of the touch panel and the remote controller described above. For example, various devices can be assumed such as a voice input device, a gesture input device, a pointing device, a joystick, a touch pad etc.

The first input screen display unit should be capable of displaying, on the display unit, the first input device screen for receiving input of the first option that can be selected through the first input device. That is, the options to be selected by the first input device should be prepared as the first options and the options should be displayed on the first input device screen so that a user I/F for the input from the first input device is formed. The first options should be options that can be selected through the first input device and the first options are displayed to be able to be selected by the first input device.

For example, if the first input device is a touch panel, the first options are formed by buttons that can be selected by touch etc., and if the first input device is a pointing device, the first options are formed by buttons that can be selected and the first options can be selected by a pointer or a cursor etc. The content selected by the options may be of various content, and can be selected from commanding execution of various processing, selecting various parameters, selecting menu layers that are formed hierarchically etc. The first input device should be capable of inputting any position on the display unit and may be a device other than the touch panel such as a gesture input device. Either way, the first input device should be capable of directly selecting any options displayed on the display unit by directly inputting (with one action) any position of the display unit.

The second input screen display unit should be capable of displaying the second input device screen on the display unit, in which the second input device screen is for receiving input of the second option that is selected by the second input device and in which a function that differs from the function selected in the first option is selected. That is, the options to be selected by the second input device should be prepared as the second options and the options should be displayed on the second input device screen so that a user I/F for the input from the second input device is formed. The second options are displayed to be able to be selected by the second input device and are different options from the first options.

That is, in the first input device and the second input device, the options that can be selected through each input device should be different. When there is no need to completely match the options that can be selected through different input devices, it is possible to prepare options that are suitable for each input device by excluding options for the input devices that seem to be troublesome. As a result, it is possible to reduce the time and effort involved in performing input with the input device.

The first options and the second options are different and the options that can be listed in the first input device screen and the second input device screen are not the same. However, a part of the first options and the second options may be the same and a function that can be implemented by using the first input device screen may be able to be implemented by using the second input device screen.

The configuration of the menu layers and the object to be displayed on the second input device screen may have various forms. For example, the second input device screen may display on one menu layer, options that are on different menu layers in the first input device screen. FIG. 5B illustrates an example in which options for changing the scale of the map are added to the options for switching the attribute of the facilities to be displayed illustrated in FIG. 2B.

If the first input device screen is used, the options for switching the attribute of the facilities to be displayed can be selected on the menu layer three layers deep from the top layer (top: FIG. 2A, second layer: FIG. 3A, third layer: FIG. 3B). The options for changing the scale of the map (buttons 45a, 45e) can be selected on the top menu layer (FIG. 2A). These options are included in the remote controller menu 51 serving as the second input device screen illustrated in FIG. 5B. Thus, in the example illustrated in FIG. 5B, the second input device screen displays on one menu layer, options that are on different menu layers in the first input device screen. With this configuration, options for which many layer transitions are necessary in the first put device screen can be selected with few layer transitions. Thus, it is possible to select options that are frequently used with few layer transitions and a few number of operations by displaying the frequently used options on the second input device screen.

The options that are on a menu layer of a specific depth in the first input device screen may be on a menu layer that is higher than the specific depth in the second input device screen. For example, when the first input device screen is used in the example illustrated in FIG. 5B, the options for switching the attribute of the facilities to be displayed are three layers deep from the top layer. When any button of the remote controller 50 is operated, the remote controller menu 51 serving as the second input device screen illustrated in FIG. 5B is displayed. Thus, the remote controller menu 51 illustrated in FIG. 5B is the top layer in the second input device screen.

In the example illustrated in FIG. 5B, the options on the menu layer three layers deep from the top layer in the first input device screen are on the menu layer which is the top layer in the second input device screen. With the configuration described above, in the second input device, it is possible to select a specific option with less layer transitions and operations than the operations in the first input device.

The functions that can be selected by the second options may include functions that cannot be selected by the first input device. For example, in the embodiment described above, since the touch panel that is the first input device is provided in the user I/F of the navigation system, only the functions that are related to the navigation system can be selected. However, since the remote controller is a device that is different from the navigation system, functions of another device such as an audio device, an air conditioner, or opening/closing of windows of a vehicle may be selected by the second option. The functions that cannot be selected by the second input device may be included in the functions that can be selected by the first option.

Sounds may be used when receiving input using the second input device. The configuration can be implemented by having the control unit 20 function as a guiding unit that performs guidance by sound for receiving input of the second option in which a function that can be selected by the second input device and that is different from the function selected in the first option is selected, instead of the second input screen display unit 21d described above or in addition to the second input screen display unit 21d. In this case, displaying the remote controller menu 51 illustrated in FIG. 2B is optional. For example, a configuration in which the control unit 20 controls a microphone of the user I/F and performs guidance by a sound (for example, speech) indicating the second option that is presently, selected every time the remote controller 50 is operated may be adopted.

The technique of displaying different options for each input device for the screen of each input device according to the various embodiments can be applied as a program or a method. In addition, it can be assumed that the system, program, and method described above are implemented as a single device or implemented by a plurality of devices. The system, program, and method include a variety of aspects. For example, it is possible to provide a navigation system, a method, and a program that include the means described above. Various changes may also be made. For example, some units may be implemented using software, and others may be implemented using hardware. Further, the present invention may be implemented as a recording medium for a program that controls the system. The recording medium for the software may be a magnetic recording medium or a magneto-optical recording medium. The same applies to any recording medium that will be developed in the future.

### DESCRIPTION OF THE REFERENCE NUMERALS

10 . . . Navigation system, 20 . . . Control unit, 21 . . . Navigation program, 21a . . . First input receiving unit, 21b . . . Second input receiving unit, 21c . . . First input screen display unit, 21d . . . Second input screen display unit, 30 . . . Recording medium, 30a . . . Drawing information, 41 . . . GPS reception unit, 42 . . . Vehicle speed sensor, 43 . . . Gyro sensor, 44 . . . Communication unit, 45 . . . User 1/F unit, 45a to 45g . . . Button, 46a to 46d . . . Button, 47 . . . Button, 50 . . . Remote controller, 50a to 50g . . . Button, 50h . . . Rotation input unit, 51 . . . Remote controller menu

1. A navigation system comprising:
a first input receiving unit that receives selection of a first option through input to a first input device to which any position on a display unit is input;
a second input receiving unit that receives input to a second input device that includes a button that issues a command to switch a second option that is selected to the second option that is positioned in a specific direction and a button that issues a command to determine an option;
a first input screen display unit that displays on a display screen, a first input device screen for receiving input of the first option that is configured to be selected by the first input device; and
a second input screen display unit that displays on the first input device screen, a second input device screen when input to the second input device is received, the second input device screen being for receiving input of the second option and the second option being arranged on the second input device screen in a direction corresponding to the specific direction, the second option being configured to be selected by the second input device and in which a function that is different from a function selected in the first option is selected.

2. The navigation system according to claim 1, wherein
the first input device is a touch panel and the second input device is a remote controller.

3. The navigation system according to claim 1, wherein
the second option is arranged linearly in the direction corresponding to the specific direction.

4. The navigation system according to claim 1, wherein
the first input device screen and the second input device screen have configurations in which details of an option selected on a higher menu layer are selected by an option on a lower menu layer, and
the number of times the menu layer needs to be switched to select a specific function in the second input device screen is less than the number of times the menu layer needs to be switched to select the specific function in the first input device screen.

5. The navigation system according to claim 4, wherein
options that are on different menu layers in the first input device screen are displayed on one menu layer in the second input device screen.

6. The navigation system according to claim 4, wherein
an option that is on the menu layer of a specific depth in the first input device screen is on the menu layer that is higher than the specific depth in the second input device screen.

7. The navigation system according to claim 1, wherein
a function that is not configured to be selected by the first input device is included in a function that is configured to be selected by the second input device.

8. The navigation system according to claim 1, wherein
the second option is an option for selecting a destination.

9. A navigation system comprising:
a first input receiving unit that receives selection of a first option through input to a first input device to which any position on a display unit is input;
a second input receiving unit that receives input to a second input device that includes a button that issues a command to switch a second option that is selected to another second option and a button that issues a command to determine an option;
a first input screen display unit that displays on a display screen, a first input device screen for receiving input of the first option that is configured to be selected by the first input device; and
a guiding unit that performs guidance by sound for receiving input of the second option that is configured to be selected by the second input device and in which a function that is different from a function selected in the first option is selected.

10. A navigation program that causes a computer to function as:
a first input receiving unit that receives selection of a first option through input to a first input device to which any position on a display unit is input;
a second input receiving unit that receives input to a second input device that includes a button that issues a command to switch a second option that is selected to the second option that is positioned in a specific direction and a button that issues a command to determine an option;
a first input screen display unit that displays on a display screen, a first input device screen for receiving input of the first option that is configured to be selected by the first input device; and
a second input screen display unit that displays on the first input device screen, a second input device screen when input to the second input device is received, the second input device screen being for receiving input of the second option and the second option being arranged on the second input device screen in a direction corresponding to the specific direction, the second option being configured to be selected by the second input device and in which a function that is different from a function selected in the first option is selected.
